(19) United States
(12) Patent Application Publication
(10) Pub. No.: US 2007/0008252 A1
(43) Pub. Date: Jan. 11, 2007

(54) Drive apparatus and drive method for light-emitting display panel

(75) Inventor: Shuichi Seki, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo (JP)

(21) Appl. No.: 11/480,554

(22) Filed: Jul. 5, 2006

(30) Foreign Application Priority Data
Jul. 7, 2005 (JP) 2005-198352

(51) Int. Cl. G09G 3/30

(52) U.S. Cl. 345/76

(57) ABSTRACT

A display data detection means 4b detects whether arrangements of video data corresponding to one scan and video data corresponding to the next scan are the same. When it is judged that the arrangements are not the same, the display data detection means 4b issues instructions to open gates to AND gates 6 and 7. Therefore, when the arrangements of the video data of two consecutive scanning lines are not the same, the data driver 2 operates for every scan, and outputs display data which are different for every scan to a display panel. When the above-mentioned display data detection means 4b judges that the arrangements of the video data of the two consecutive scanning lines are the same, the gates of AND gates 6 and 7 are closed. Thus, the operation of the data driver 2 is stopped, and a latch circuit in the data driver 2 holds the previous video data and outputs the same display data for every scan to the display panel. Since the drive for the data driver 2 which operates at high speed at a comparatively high drive voltage is stopped temporarily, it is possible to realize low power consumption.

### BACKGROUND OF THE INVENTION

1. Field of the Invention

The present invention relates to a light-emission drive technology for a light-emitting display panel in which light emitting elements are arranged in a matrix pattern, in particular to a drive apparatus and a drive method for a light-emitting display panel which realize low power consumption.

2. Description of the Related Art

A display employing a display panel which is constructed by arranging light emitting elements in a matrix pattern has been developed widely. As the light emitting element employed in such a display panel, an organic EL (electroluminescence) element in which an organic material is employed in a light emitting layer has attracted attention, for example. There is also part of the background that a light emitting layer of an EL element employs an organic compound which can expect a good light-emission property, so that the organic EL display panel has as high an efficiency and long a lifetime as can be put into practical use.

As a display panel employing such organic EL elements, a passive matrix type display panel in which EL elements as light emitting pixels are simply arranged in a matrix pattern and an active matrix type display panel in which each drive element constituted by TFT's (thin film transistors), for example, is added to a respective one of the above-mentioned EL elements arranged in a matrix pattern have been proposed.

The former passive matrix type display panel has a feature in which a structure of a display panel can be simplified. The latter active matrix type display panel has a feature of reducing cross talk between pixels in comparison with the former passive matrix type display panel.

In either the above-mentioned passive matrix type display panel or active-matrix type display panel, a drive apparatus which causes and drives these to emit light basically includes a scanning driver for selectively scanning each scanning line arranged at the display panel, a data driver for supplying a display signal to each pixel containing an EL element arranged at the display panel synchronizing with the above-mentioned scanning, and a controller for controlling the above-mentioned scanning driver and data driver.

FIG. 1 shows an example of a drive apparatus for the latter active-matrix type display panel. Namely, reference numeral 1 denotes a display panel in which the above-mentioned pixels are arranged in a matrix pattern, for example, on a glass substrate. This display panel 1 is connected with a data driver 2 and a scanning driver 3, and further provided with a controller 4 for controlling the above-mentioned data driver 2 and the scanning driver 3.

The above-mentioned data driver 2 is arranged to acquire from the controller 4 video data for every pixel corresponding to one horizontal scan via a data bus 5a, and to supply a source voltage corresponding to the above-mentioned video data to a source of a scanning transistor of a TFT constituting a pixel. Therefore, the above-mentioned data driver 2 is provided with a shift register, a latch circuit, etc., as will be described later.

In order to drive and control these circuits, it is arranged such that control signals, such as a shift clock (Shift Clock), a start pulse (Start Pulse), a latch pulse (Latch Pulse), etc., may be supplied from the controller 4 to the data driver 2 via a bus line 5b.

On the other hand, the above-mentioned scanning driver 3 supplies a gate turn-on voltage alternatively to each scanning line (hereafter also referred to as scanning line) scanned during an address period, operates to carry out ON operation of scanning transistors one by one whose gates are connected to the respective scanning lines, so as to respectively write the video data to each pixel. For this reason, the above-mentioned scanning driver 3 is provided with a shift register etc., as will be described later. In order to drive and control these circuits, it is arranged such that a scanning shift clock signal (Shift Clock), a scanning start pulse (Start Pulse), etc., may be supplied from the controller 4 to the scanning driver 3 via a bus line 5c.

In addition, as for the drive apparatus for the light-emitting display panel using the EL elements for the display pixel as shown in FIG. 1, the structure provided with the data driver 2, the scanning driver 3, and the controller 4 is disclosed in many patent documents, an example of which is patent document 1 as follows: [Patent Document 1] Japanese Patent Publication (KOKAI) 2002-32057

Incidentally, the above-mentioned data driver 2 and scanning driver 3 generally have a high operation voltage, and therefore consumes considerable power. In contrast, the controller 4 for controlling each of the above-mentioned drivers is mostly constituted by logical circuits, its operational voltage is low, and its power consumption is very low as compared with that of each of the above-mentioned drivers. In addition, the above-mentioned controller and each driver do not have to be constructed by separate chips, but may be constructed by one chip. Even when they are thus constructed by one chip, the inside of which is divided into the controller and the driver, and their operational voltages are generally different from each other, as described above.

Further, in the structure as shown in FIG. 1, the shift clock signal, the start pulse, the latch pulse, etc. which are supplied from the controller 4 to the data driver 2 are generated at predetermined regular periods of time regardless of the displayed video data, and they are always supplied to the data driver 2. Therefore, the data driver 2 operates so that the source voltage may be repeatedly supplied at predetermined time intervals to the source of the scanning transistor which constitutes a pixel.

Further, regardless of the displayed video data, the scanning shift clock and scanning start pulse which are supplied from the controller 4 to the scanning driver 3 are similarly generated at predetermined regular periods of time, and which are always supplied to the scanning driver 3. Therefore, the scanning driver 3 operates so that the gate turn-on voltage may be repeatedly supplied at predetermined time intervals to the gate of the scanning transistor which constitutes a pixel. In consecutive plural scans, even if the arrangements of the display signals supplied to the respective pixels are the same, similar drive operation is continued and performed.

Incidentally, as described above, when the arrangements of the display signals supplied to the respective pixels are the same in consecutive plural scans, even if the data in the above-mentioned data driver, for example, data latched in the latch circuit are not rewritten for every scan, the display is not disturbed as a result. In other words, in the above-mentioned conditions, even if the rewriting operation of the above-mentioned latch circuit etc. is stopped, no disturbance is caused to the display and the power consumption associated with the rewriting operation of the latch circuit etc. can be reduced as a result.

### SUMMARY OF THE INVENTION

Based on the technical viewpoint as described above, the present invention has been made and aims to provide a drive apparatus and a drive method for a light-emitting display panel employing a means for stopping operation of the above-mentioned data driver which needs comparatively large drive power when the arrangements of the display signals supplied to the respective pixels for respective scanning lines in consecutive scans are the same, thus realizing low power consumption.

The drive apparatus for the light-emitting display panel in accordance with the present invention, made in order to solve the above-mentioned problem, is a drive apparatus for a light-emitting display panel in which pixels containing a light emitting element are arranged in respective intersections where a plurality of data lines intersect with a plurality of scanning lines respectively, characterized by including a scanning driver connected to each of the above-mentioned scanning lines, and selectively performs scan of each of the above-mentioned scanning lines, a data driver for supplying a display signal to each of the above-mentioned pixels, and a controller for controlling the above-mentioned scanning driver and data driver, and by comprising a first control means for stopping the supply of the display signal from the above-mentioned controller to the above-mentioned data driver and a second control means for stopping the supply of the control signal from the above-mentioned controller to the above-mentioned data driver.

Further, the drive method for the light-emitting display panel in accordance with the present invention, made in order to solve the above-mentioned problem, is a drive method for a light-emitting display panel in which pixels containing a light emitting element are arranged in respective intersections where a plurality of data lines intersect with a plurality of scanning lines respectively, the light-emitting display panel including a scanning driver connected to each of the above-mentioned scanning lines in above-mentioned light-emitting display panel, and selectively performs scan of each of the above-mentioned scanning lines, a data driver for supplying a display signal to each of the pixels in above-mentioned light-emitting display panel, and a controller for controlling the above-mentioned scanning driver and data driver, wherein when it is detected that arrangements of display signals supplied to the above-mentioned respective pixels are the same in consecutive plural scans, the supply of the display signal to the above-mentioned data driver from the above-mentioned controller is stopped, and the supply of the control signal to the above-mentioned data driver from the above-mentioned controller is stopped.

### BRIEF DESCRIPTION OF THE DRAWINGS

FIG. 1 is a block diagram showing a basic structure in a drive apparatus for a light-emitting display panel in accordance with the present invention;

FIG. 2 is a wiring diagram showing an example of a structure of pixel portions arranged in the light-emitting display panel as shown in FIG. 1;

FIG. 3 is a block diagram showing an example of a data driver as shown in FIG. 1;

FIG. 4 is a timing chart for each signal supplied to the data driver as shown in FIG. 1;

FIG. 5 is a timing chart for each signal supplied to a scanning driver as shown in FIG. 1;

FIG. 6 is a block diagram showing an example of an internal structure of a controller as shown in FIG. 1;

FIG. 7 is a schematic representation for explaining operation when arrangement comparison results of video data carried out in the controller are not the same;

FIG. 8 is a schematic representation for explaining operation when the arrangement comparison results of the video data carried out similarly are the same;

FIG. 9 is a block diagram showing another example of the internal structure of the controller as shown in FIG. 1;

FIG. 10 is a schematic representation showing an example of a drive apparatus formed into an IC chip for the light-emitting display panel;

FIG. 11 is a schematic representation for explaining operation of gradation expression by way of a simple sub-frame method; and

FIG. 12 is a schematic representation for explaining operation of the gradation expression by way of a weighting sub-frame method.

### DESCRIPTION OF THE PREFERRED EMBODIMENTS

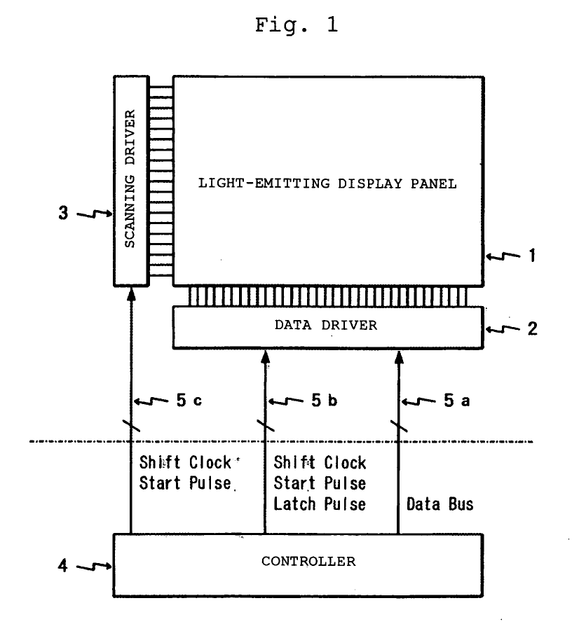

Hereafter, a preferred embodiment of a drive apparatus for a light-emitting display panel in accordance with the present invention will be described with reference to drawings. In addition, a basic structure of the drive apparatus in accordance with the present invention can be expressed similarly to the block diagram shown in FIG. 1 as already described. A detailed structure for every block as shown in FIG. 1 will be described below.

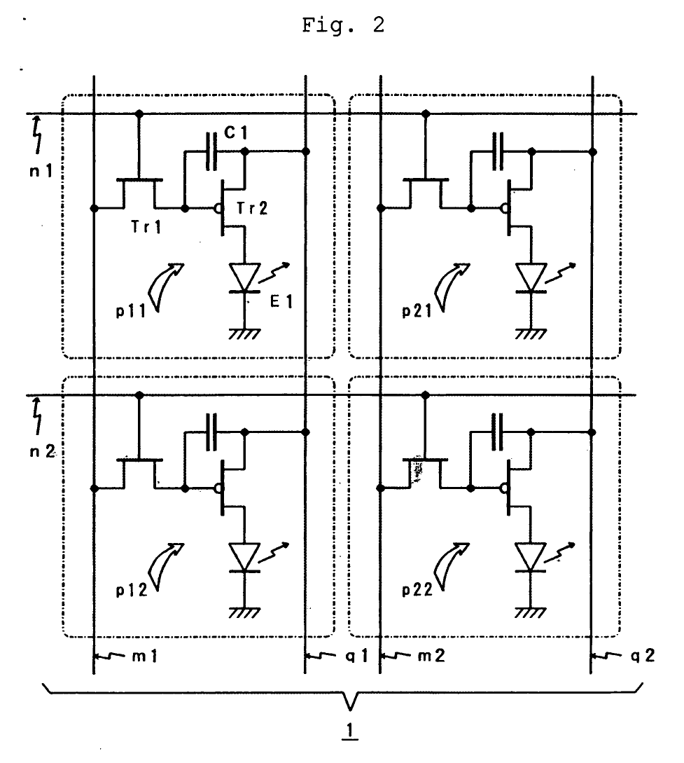

FIG. 2 shows an example of a structure of pixels arranged in the light-emitting display panel 1 as shown in FIG. 1. In this display panel 1, four groups of display pixels p11, p12, p21, and p22 are shown representing the display pixels arranged in a matrix pattern. In the display panel 1, data lines m1, m2, which are connected to the above-mentioned data driver 2 are arranged vertically (in a column direction), and scanning lines n1, n2, which are connected to the above-mentioned scanning driver 3 are arranged horizontally (in a row direction). Furthermore, corresponding to the respective above-mentioned data lines, power supply lines q1, q2, . . . which are connected to a power supply circuit (not shown) are also arranged vertically in the display panel 1.

As for each of the above-mentioned light-emitting display pixels, FIG. 2 shows a structure arranged by way of the most fundamental conductance control method. In other words, each element which constitutes the pixel p11 in the top left-hand corner in the display panel 1 as shown in FIG. 2 is as denoted by a reference sign, and a gate of a scanning transistor Tr1 constituted by n channel type TFT's is connected to the scanning line n1, and a source is connected to the data line m1. Further, a drain of the scanning transistor Tr1 is connected with a gate of a transistor Tr2 for lighting and driving constituted by p channel type TFT's, and also connected to one terminal of a capacitor C1 for storing charges.

A source of the transistor Tr2 for lighting and driving is connected to the other terminal of the above-mentioned capacitor C1 and also connected to the power supply line q1. Further, a drain of the transistor Tr2 for lighting and driving is connected with an anode terminal of an organic EL element E1 as a light emitting element, and a cathode terminal of the EL element E1 is connected with a reference potential point (ground) of a circuit. Thus, a large number of light-emitting display pixels with the above-mentioned structure are arranged on the display panel 1 vertically and horizontally in a matrix pattern, as described above.

In the structure as shown in FIG. 2, when the turn-on voltage is supplied from the scanning driver 3, via the scanning line n1, to the gate of the scanning transistor Tr1 in the light-emitting display pixel p11, the scanning transistor Tr1 causes electric current corresponding to the source voltage supplied to the source through the data line m1 to flow from the source to the drain. Therefore, during a period when the gate of the scanning transistor Tr1 is at the turn-on voltage, the above-mentioned capacitor C1 is charged to a voltage corresponding to the above-mentioned source voltage. The charged voltage is supplied to the gate of the transistor Tr2 for lighting and driving. Thus, the transistor Tr2 for lighting and driving passes the electric current based on a gate-source voltage (Vgs) to the EL element E1, and causes and drives the EL element to emit light.

On the other hand, when the gate of the scanning transistor Tr1 reaches a turn-off voltage, the gate voltage of the transistor Tr2 for lighting and driving is held by the charge accumulated in the capacitor C1, although the scanning transistor Tr1 is so-called cut-off and the drain of the transistor is in an open state. Therefore, drive current for the transistor Tr2 for driving is maintained till the next scan, whereby the light-emission from the EL element E1 is also maintained.

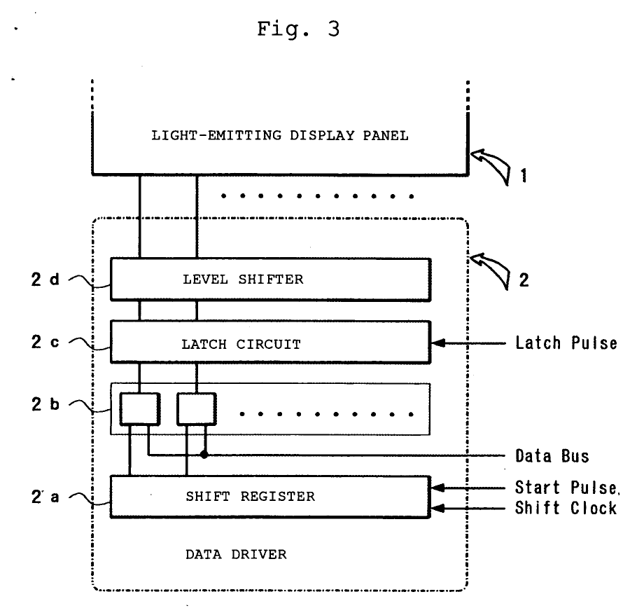

FIG. 3 shows a structure of the data driver 2 which receives the display signal on a pixel by pixel basis, i.e., a video datum via the data bus 5a from the above-mentioned controller 4, similarly receives the shift clock, the start pulse, and the latch pulse as the control signals, and transmits a data write-in signal (the above-mentioned source voltage) from the controller 4 via the data bus 5a to each pixel of the light-emitting display panel 1 for every scan.

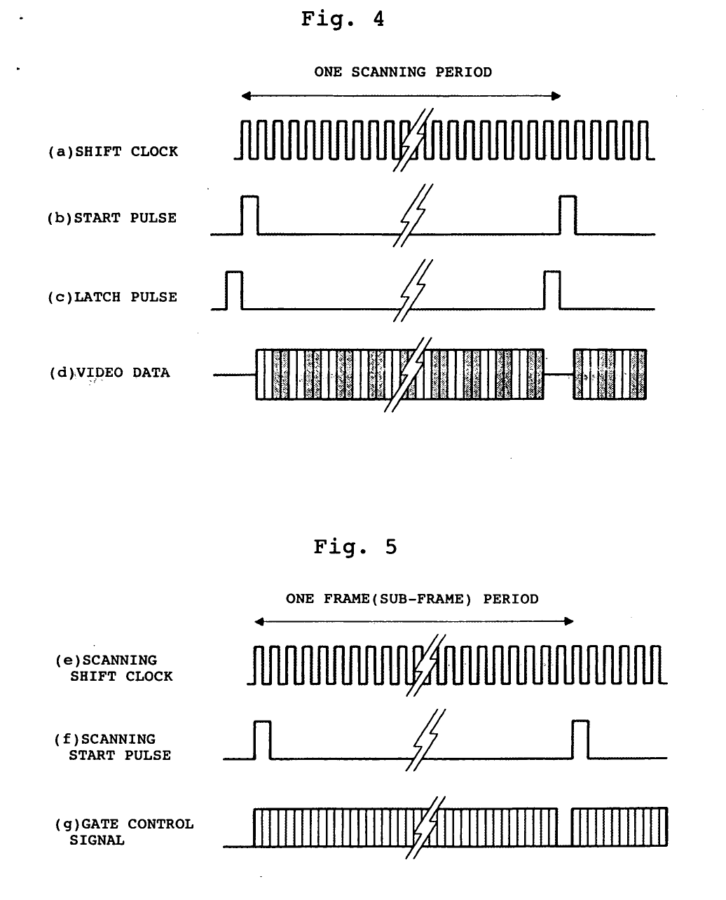

This data driver 2 is provided with a shift register 2a. This shift register 2a is supplied with a start pulse as shown by reference sign (b) and a shift clock as shown by reference sign (a) in FIG. 4. Based on these shift clock and start pulse, the above-mentioned shift register 2a generates a timing signal in order, and it acts such that this timing signal may be supplied to a first latch circuit 2b in order.

The above-mentioned first latch circuit 2b has respective latches for a plurality of stages for processing the video data, as shown by reference sign (d) in FIG. 4, corresponding to the respective pixels. It acts such that the video data supplied via the data bus 5a may be written and held in the respective latches in order by the timing signals supplied in order from the above-mentioned shift register 2a. After the writing of the video datum for one scanning line in this first latch circuit 2b is completed, the latch pulse as shown by reference sign (c) in FIG. 4 is supplied to a second latch circuit 2c.

Thus, the video data for one line written into the first latch circuit 2b are transmitted to the second latch circuit 2c all at once. Then, after the first latch circuit 2b has transmitted the video data for one line to the second latch circuit 2c, video data for a subsequent line are written again in the first latch circuit 2b in response to the timing signal from the shift register 2a.

The video datum corresponding to each pixel latched in the above-mentioned second latch circuit 2c is supplied to a level shifter 2d. The video data converted into those of a predetermined level by this level shifter 2d are supplied, as write-in signals (source voltages), to the transistor Tr1 being scanning through the respective data lines m1, m2, . . . of the display panel 1 as shown in FIG. 2.

In addition, although not shown in the drawings, the scanning driver 3 as shown in FIG. 1 is provided with a shift register for scanning and a level shifter which converts the timing signal outputted sequentially from the shift register into that of a predetermined level. Further, receiving the scanning shift clock and the scanning start pulse as shown by reference signs (e) and (f) in FIG. 5 from the controller 4 during an address period, the above-mentioned shift register for scanning in the scanning driver 3 generates a timing signal in order. As described above, this timing signal is converted into that of the predetermined level by the level shifter, and acts such that the gate turn-on voltages may be supplied in turn to the respective scanning lines n1, n2, . . . of the display panel 1 as shown in FIG. 2. In other words, it acts to supply a gate control signal at a timing as shown by (g) in FIG. 5.

Therefore, as described above, at the time of addressing, the respective scanning lines n1, n2, . . . which are arranged in the display panel 1 are supplied with the gate turn-on voltage one by one. Synchronizing with this, the respective data lines m1, m2, . . . are supplied with the video data for every line in order. Thus, the video data are separately written into the respective pixels in the display panel 1, and the display panel is subjected to light-emission control according to the above-mentioned video data.

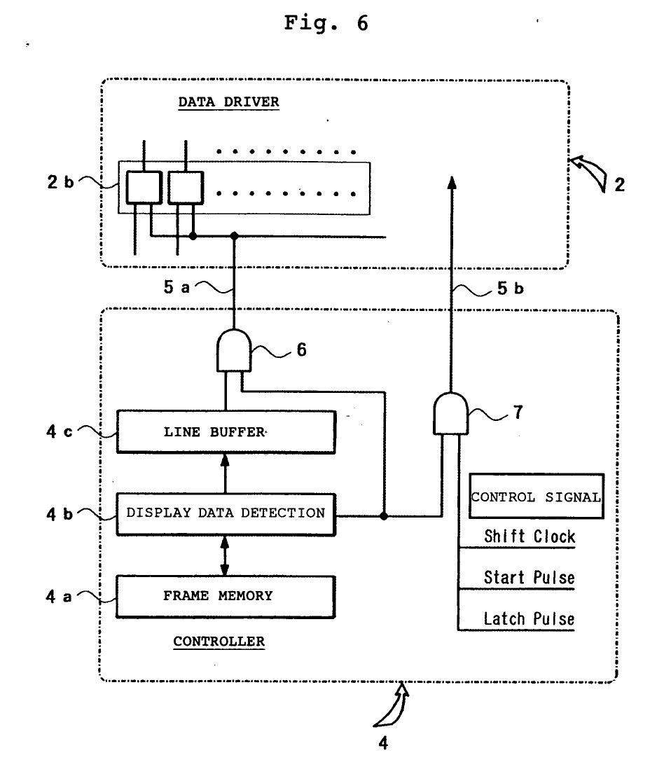

Next, FIG. 6 shows part of an internal structure of the above-mentioned data driver 2 and the controller 4. As shown in FIG. 6, the controller 4 is provided with a frame memory 4a which can store the display signal for one frame on a pixel by pixel basis, i.e., the video data, and this frame memory 4a is connected with a display data detection means 4b. This display data detection means 4b operates so that it may detect whether the arrangements of the video data which are read from the above-mentioned frame memory 4a for the respective consecutive scanning lines are the same.

For this reason, the above-mentioned display data detection means 4b is provided with a line memory (not shown) which stores in series the video data corresponding to one scan and has a function which compares respectively on a datum by datum basis whether the arrangements of the video data are the same or not between the above-mentioned video data stored in this line memory and the video data corresponding to a next scan.

Here, when the display data detection means 4b judges that the arrangements of the video data of two consecutive scanning lines are not the same, the operation is such that a control datum “1” may be respectively outputted from the display data detection means 4b to an AND (logical multiplication) gate 6 which functions as the first control means and an AND (logical multiplication) gate 7 which functions as the second control means, whereby both the above-mentioned AND gates 6 and 7 are caused to be open.

As described above, since the AND gate 6 which functions as the first control means is caused to be open, the operation is such that the video data corresponding to one scanning line transmitted to a line buffer 4c from the line memory (not shown) in the display data detection means 4b may be supplied via the AND gate 6 and the data bus 5a to the above-mentioned first latch circuit 2b provided for the data driver 2.

Further, since the AND gate 7 which functions as the second control means is caused to be open, the operation is such that the control signal for driving the above-mentioned data driver 2 generated in the controller 4, i.e., the shift clock signal, the start pulse, and the latch pulse may be supplied through the above-mentioned AND gate 7 and data bus 5b to the data driver 2, respectively.

On the other hand, according to the above-mentioned operation by means of the structure as shown in FIG. 6, when it is judged that the arrangements of the video data of two consecutive scanning lines are the same, the operation is such that a control data “0” may be outputted from the above-mentioned display data detection means 4b to the first and second AND gates 6 and 7. Thus, both the above-mentioned AND gates 6 and 7 are caused to be closed. Therefore, the transmission of the video data from the above-mentioned line buffer 4c to the data driver 2 is stopped, at the same time the transmission of the above-mentioned control signals (shift clock signal, start pulse, latch pulse) from the controller 4 to the data driver 2 is also stopped.

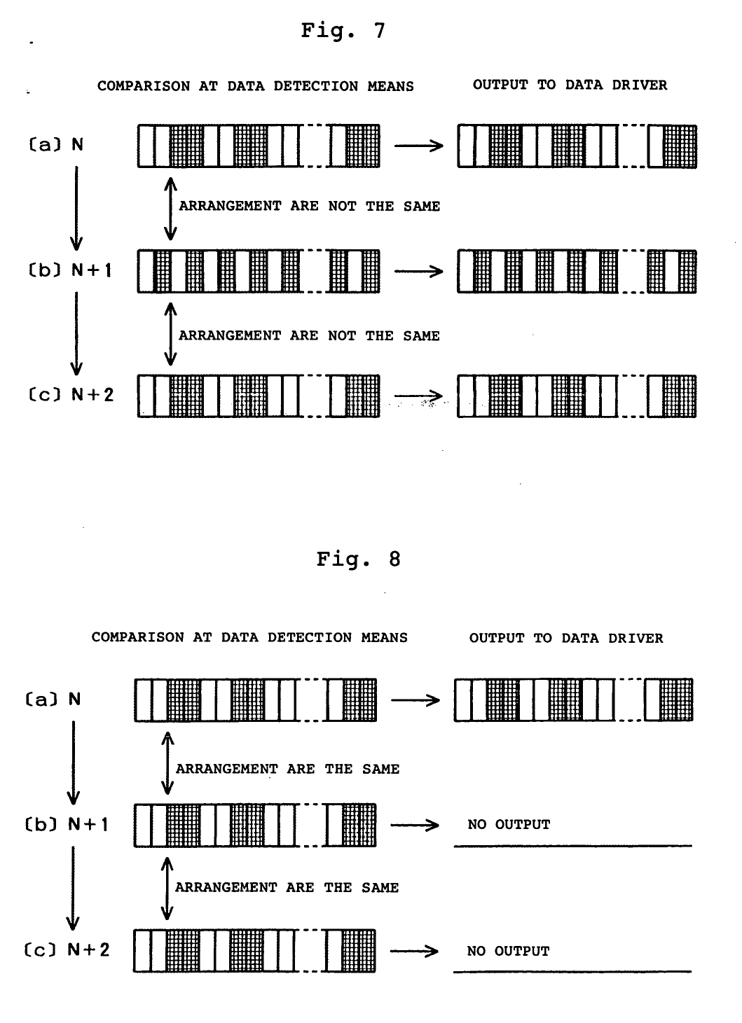

FIGS. 7 and 8 schematically explain arrangement comparison of the video data in the above-mentioned controller 4 and transmission operation of the video data to the data driver, in which FIG. 7 explains operation in the case where the arrangements of the video data of two consecutive scannings are not the same, and FIG. 8 explains operation in the case where the arrangements are the same.

Reference sign (a) in FIG. 7 shows the video data (Nth video data) corresponding to a certain scan, and reference sign (b) shows the video data (N+1th video data) corresponding to a subsequent scan. Here, the above-mentioned display data detection means 4b takes the Nth video data into the line memory (not shown) and compares the arrangements of the Nth video data and the N+1th video data. At this time, the Nth video data taken into line memory are outputted to the data driver 2 via the line buffer 4c, the AND gate 6, and the data bus 5a, and are used in the Nth scan.

According to the resulting comparison of the arrangement of the above-mentioned Nth video data with that of the N+1th video data, when it is judged that the arrangements of both the data are not the same (Nth data≠N+1th data), the above-mentioned AND gate 6 is caused to be open at the timing when the next N+1th data are taken into the above-mentioned line memory. Therefore, the N+1th data taken into the line memory are supplied to the data driver 2 via the line buffer 4c, the gate 6, and the data bus 5a, and are used in the N+1th scan.

Then, the display data detection means 4b compares the arrangement of the N+1th video data as shown in FIG. 7 (b) taken into the above-mentioned line memory, with further subsequent video data (N+2th video data) as shown by (c). According to the resulting comparison, when it is judged that the arrangements of both the data are not the same (N+1th data≠N+2th data), the above-mentioned AND gate 6 is caused to be open at the timing when the next N+2th data are taken into the above-mentioned line memory. Therefore, similarly the operation is such that the N+2th data taken into the line memory are supplied to the data driver 2 through the line buffer 4c, the gate 6, and the data bus 5a and are used in the N+2th scan.

On the other hand, reference signs (a) and (b) in FIG. 8 similarly show the Nth video data and the N+1th video data, the display data detection means 4b takes the Nth video data into the line memory (not shown) and compares the arrangement of the Nth video data and that of the N+1th video data. At this time, the Nth video data taken into the line memory are outputted to the data driver 2 through the line buffer 4c, the gate 6, and the data bus 5a, and are used in the Nth scan.

According to the resulting comparison of the arrangements of the above-mentioned Nth video data and the N+1th video data, when it is judged that the arrangements of both the data are the same (Nth data=N+1th data), the above-mentioned AND gate 6 is controlled to be closed at the timing when the next N+1th data are taken into the above-mentioned line memory. Therefore, the N+1th data taken into the line memory are not outputted to the data driver 2.

Then, the display data detection means 4b compares the arrangement of the N+1th video data shown in FIG. 8 (b) taken into the above-mentioned line memory, with further subsequent video data (N+2th video data) as shown by reference sign (c). The comparison result shows that the arrangements of both the data are the same. When it is judged that (N+1th data=N+2th data), the above-mentioned AND gate 6 is succeedingly controlled to be closed at the timing when the next N+2th data are taken into the above-mentioned line memory. Therefore, the N+2th data taken into the line memory are not outputted to the data driver 2.

In addition, in accordance with the above-mentioned operation, the second AND gate 7 is controlled to be either open or closed in synchronism, whereby the above-mentioned control signals (shift clock signal, start pulse, latch pulse) are controlled and determined whether to be transmitted from the controller 4 to the data driver 2. In particular, as shown in FIG. 8, when it is judged that the arrangements of the video data of the two consecutive scanning lines are the same, the transmission of the above-mentioned control signal to the data driver 2 is also stopped on a scan by scan basis.

Accordingly, in the data driver 2, each operation of the shift register 2a, the first latch circuit 2b, and the second latch circuit 2c stops as the transmission of each of the above-mentioned timing signals stops. Therefore, the same video data are used also in the next scan, without rewriting the video data (Nth video data as shown in FIG. 8) latched into the second latch circuit 2c. These operations are similarly performed, as long as the arrangements of the video data for the respective scans are the same, as shown in FIG. 8. Thus, even if the same video data are used in the consecutive scans, then they are not different from the original video data to be displayed, as a result.

As described above, when the arrangements of the video data of the two consecutive scanning lines are the same, since each operation of the shift register 2a, the first latch circuit 2b, and the second latch circuit 2c in the data driver 2 is temporarily stopped, it is possible to contribute to reducing the power consumption in the data driver 2 which operates at high speed at a comparatively high voltage level.

In addition, as described above, although it is necessary for the display data detection means 4b on the controller 4 side to have the line memory for storing in series the video data corresponding to each scan or a function which compares the above-mentioned video datum stored in this memory with video data of the next scan on a pixel by pixel basis respectively, these can be constituted by a logical circuit of a low voltage, thus their power consumption is very low. Therefore, it is possible for the data driver 2 and the whole controller 4 to realize low power consumption.

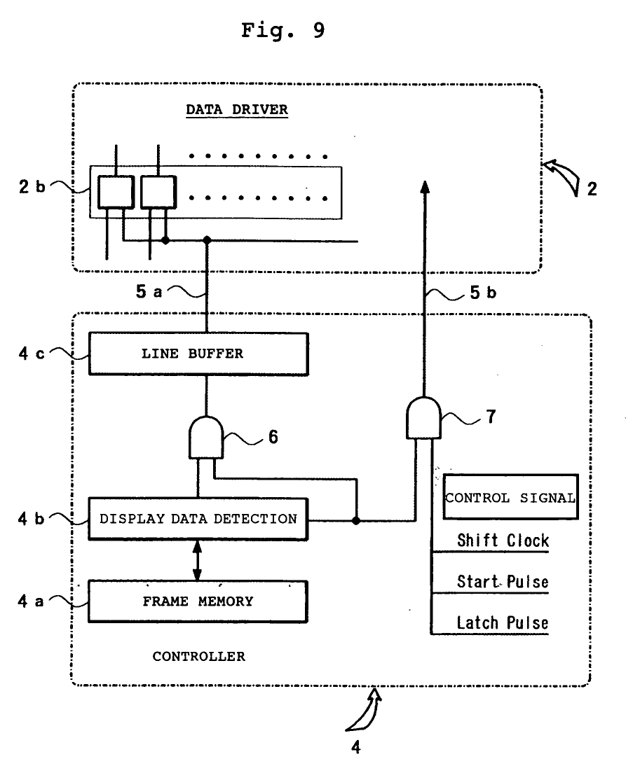

FIG. 9 shows another example of a structure of the above-mentioned controller 4, in which like parts (as already explained) equivalent to those of the controller as shown in FIG. 6 are denoted with like reference signs. In the structure as shown in this FIG. 9, the AND gate 6 which functions as the first control means is connected between the display data detection means 4b and the line buffer 4c. Also in this structure, it is possible to obtain operational effects similar to those in the preferred embodiment as shown in FIG. 6.

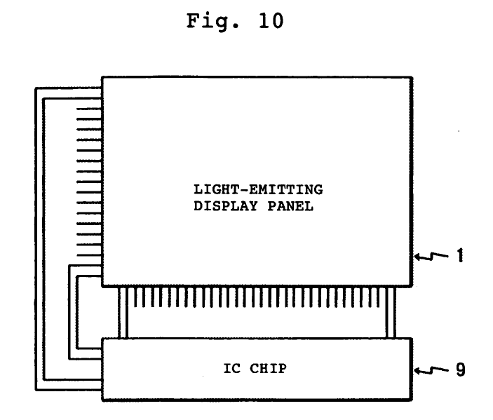

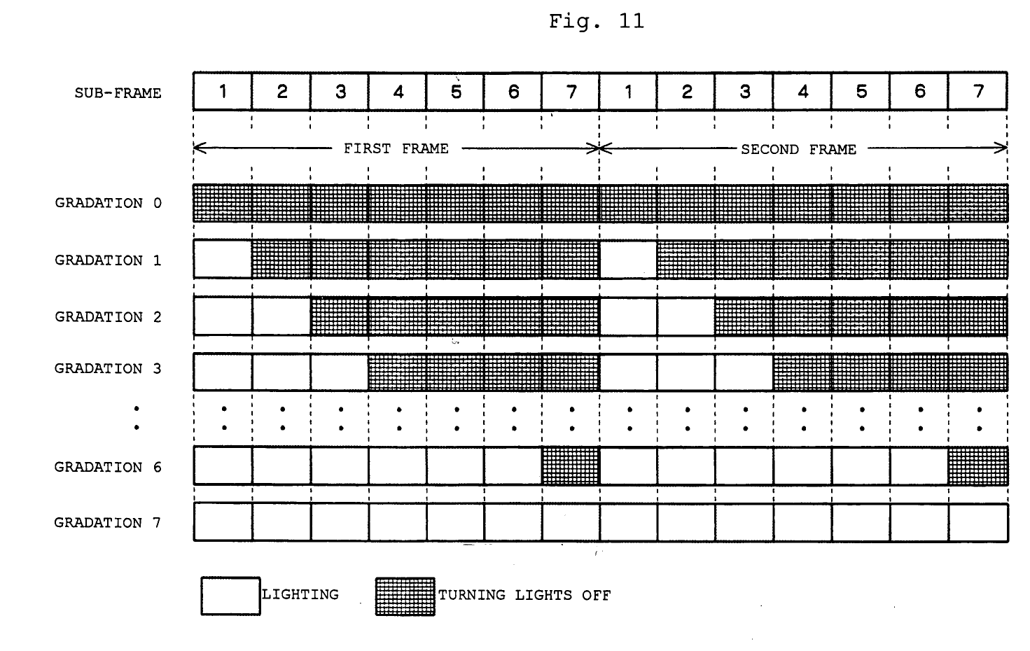

Further, in the above-mentioned preferred embodiments, although each of the controller 4, the data driver 2, and the scanning driver 3 is constructed independently, they can also be constituted by one IC chip as denoted with reference numeral 9 in FIG. 10. In this case, the above-mentioned IC chip 9 made into one chip may be formed of a TFT on a glass substrate which constitutes the display panel 1, for example.

Incidentally, a time gradation method is proposed as a method for performing gradation expression of an image signal by using a circuit structure as described above. This time gradation method is a method in which, for example, one frame period is temporally divided into a plurality of sub-frame periods, and sub-frame periods when a light emitting element emits light are summed for one frame period to perform intermediate display.

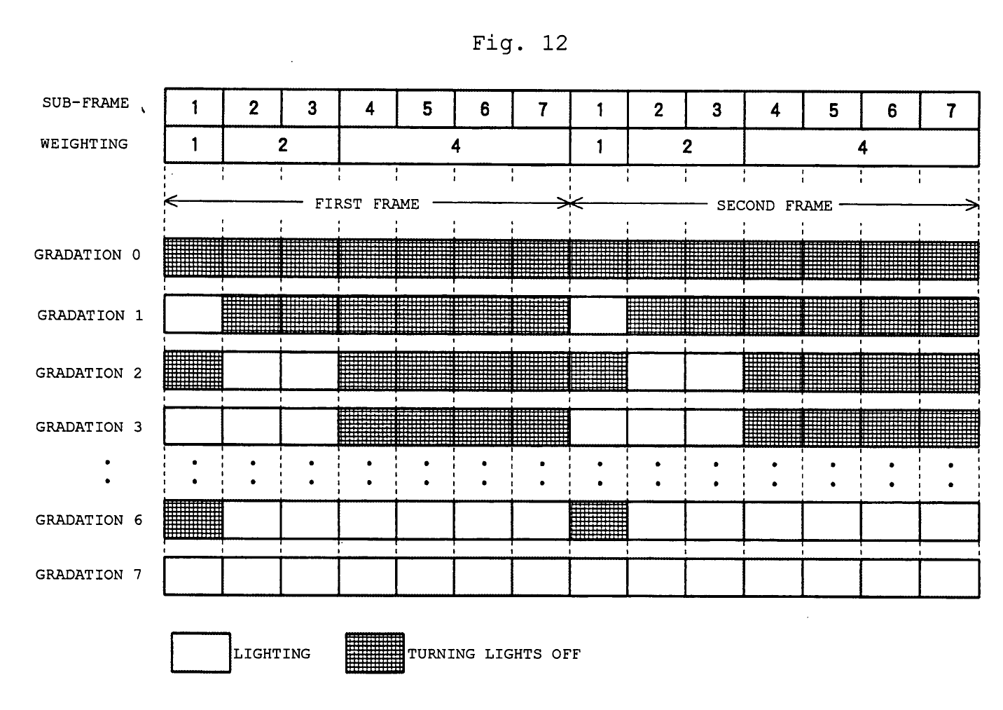

Examples of this time gradation method are a method (simple sub-frame method) of causing and driving the light emitting element to emit light on a sub-frame by sub-frame basis, as shown in FIG. 11, in which gradation expression is carried out by simply summing the sub-frame periods for emitting light, and a method (weighting sub-frame method) in which one or more sub-frame periods are made into respective groups, as shown in FIG. 12, which are assigned gradation bits and weighted, and gradation expression is carried out by means of their combinations. In addition, both FIGS. 11 and 12 illustrate cases where eight gradations of “O”-“7” are expressed.

Among these, the weighting sub-frame method as shown in FIG. 12 has an advantage that, for example, by carrying out weighting control for gradation display also during the lighting period within a sub-frame period, multi-gradation expression can be realized with the number of sub-frames smaller than that of the simple sub-frame method.

In any event, in the case where the above-mentioned time gradation method is employed, since the light emitting elements are caused and driven to emit light on a sub-frame by sub-frame basis, the clock signal supplied from the above-mentioned controller 4 to the data driver 2 and the scanning driver 3 requires a frequency of at least several times that of the simple sub-frame method. Since each driver is driven with the clock signal of such a high frequency, a problem arises in that the power consumption in the data driver 2 and the scanning driver 3 increases inevitably.

Then, it is possible to contribute to reducing the power consumption in the data driver 2 by employing the structure as shown in FIG. 6 or 9 for the above-mentioned controller 4. In particular, as shown in FIG. 11, in the case of performing control to increase the number of sub-frames for lighting one by one according to gradation control sequentially from one side of a plurality of sub-frames arranged along a time axis in the two consecutive scans, a rate that the arrangement of the lighting data changes in the comparison of each scanning line decreases, and a rate that the data driver 2 can stop its operation increases, whereby further reduction in power consumption can be expected.

In addition, in the preferred embodiments as described above, although the structures are shown in which the active-matrix type display panel is caused and driven to emit light, the present invention may also be applied to a structure in which a passive matrix type display panel is caused and driven to emit light, thus similarly realizing the low power consumption. Further, although the description is carried out by using the EL elements as light emitting elements arranged in the light-emitting display panel, it is also possible to obtain the same operational effect, also when another type of self-emitting elements are used.

What is claimed is:

1. A drive apparatus for a light-emitting display panel in which pixels containing a light emitting element are arranged in respective intersections where a plurality of data lines intersect with a plurality of scanning lines respectively, said drive apparatus including:
a scanning driver connected to each of said scanning lines, and selectively performs scan of each of said scanning lines, a data driver for supplying a display signal to each of said pixels, and a controller for controlling said scanning driver and data driver, and
comprising a first control means for stopping the supply of the display signal from said controller to said data driver, and a second control means for stopping the supply of the control signal from said controller to said data driver.

2. The drive apparatus for the light-emitting display panel as claimed in claim 1, wherein said controller is provided with a display data detection means for detecting that arrangements of the display signals supplied to said respective pixels are the same in consecutive plural scans, and said first control means and second control means are arranged to be operated when said display data detection means detects that the arrangements of the display signals supplied to the respective pixels are the same in the consecutive plural scans.

3. The drive apparatus for the light-emitting display panel as claimed in claim 2, wherein one frame period is temporally divided into a plurality of sub-frames, and a gradation control means for lighting and controlling the light emitting element which constitutes each of said pixels on a sub-frame by sub-frame basis is further provided.

4. The drive apparatus for the light-emitting display panel as claimed in any one of claims 1 to 3, wherein said light emitting element is constituted by an organic EL element using an organic compound for a light emitting layer.

5. A drive method for a light-emitting display panel in which pixels containing a light emitting element are arranged in respective intersections where a plurality of data lines intersect with a plurality of scanning lines respectively, said light-emitting display panel comprising a scanning driver connected to each of said scanning lines in said light-emitting display panel, and selectively performs scan of each of said scanning lines, a data driver for supplying a display signal to each of the pixels in said light-emitting display panel, and a controller for controlling said scanning driver and data driver, wherein
when it is detected that arrangements of display signals supplied to said respective pixels are the same in consecutive plural scans, the supply of the display signal from said controller to said data driver is stopped, and the supply of the control signal from said controller to said data driver is stopped.

6. The drive method for the light-emitting display panel as claimed in claim 5, wherein one frame period is temporally divided into a plurality of sub-frames, and gradation control is performed by lighting and controlling the light emitting element which constitutes each of said pixels on a sub-frame by sub-frame basis.
